(19) United States
(12) Patent Application Publication
(10) Pub. No.: US 2020/0117926 A1
(43) Pub. Date: Apr. 16, 2020

(54) APPARATUS, METHOD, AND SYSTEM FOR CONTROLLING PARKING OF VEHICLE

(71) Applicant: MANDO CORPORATION, Pyeongtaek-si (KR)

(72) Inventor: InHo KIM, Seoul (KR)

(21) Appl. No.: 16/597,749

(22) Filed: Oct. 9, 2019

(30) Foreign Application Priority Data
Oct. 10, 2018 (KR) 10-2018-0120345

(51) Int. Cl. G06K 9/00; G08G 1/14

(52) U.S. Cl. CPC G06K 9/00812; G06T 2207/30264; G08G 1/145; G08G 1/141

(57) ABSTRACT

The present disclosure relates to an apparatus and a method for controlling a parking operation of a vehicle, and more particularly, to an apparatus and method for evaluating each available parking space in a parking area to determine a parking space. Specifically, the parking control apparatus includes: a reception unit configured to receive parking area map information from a server; an extraction unit configured to extract a candidate parking space list including one or more available parking spaces on the basis of the parking area map information; an available parking space evaluation unit configured to allocate a priority order to each of the available parking spaces included in the candidate parking space list on the basis of preset priority order allocation condition information; and a parking space determination unit configured to determine a target parking space for a subject vehicle on the basis of information on priority orders allocated to respective available parking spaces.

### CROSS REFERENCE TO RELATED APPLICATION

This application claims priority from Korean Patent Application No. 10-2018-0120345, filed on Oct. 10, 2018, which is hereby incorporated by reference for all purposes as if fully set forth herein.

### BACKGROUND OF THE INVENTION

### 1. Field of the Invention

The present disclosure relates to an apparatus and a method for controlling a parking operation of a vehicle, and more particularly, to an apparatus and method for evaluating each available parking space in a parking area to determine a parking space.

### 2. Description of the Prior Art

As vehicles have become a necessity for modern people, various research on Advanced Driver Assistance System (ADAS) technology for driver convenience is actively being carried out.

Among such reasearch, many technologies related to parking assistance systems for assisting the parking of a vehicle, such as a Parking Assistance System (PAS) and a Smart Parking Assistance System (SPAS), are being developed. These parking assistance systems assist a driver in guiding the vehicle when the vehicle is parked in a parking space or when the vehicle leaves the parking space, or provides information on the distance between the vehicle and a surrounding obstacle.

In recent years, in addition to the parking assistance systems, a technology has been developed for an automatic parking system that allows the vehicle to carry out parking by itself without intervention of the driver. Such an automatic parking system first causes the vehicle to approach a parking space for direct parking, and images the vicinity of the parking space. Then, the vehicle is controlled while confirming the captured images such that the vehicle can be parked in the parking space.

That is, the present automatic parking system can be applied when the vehicle approaches a specific parking space because parking is performed using a sensor mounted on the vehicle. Therefore, there is a limit in that, in order to use the automatic parking system, it is necessary for the driver to directly gather information on the parking space, to determine the parking space to park, and then to drive the vehicle to the vicinity of the parking space.

### SUMMARY OF THE INVENTION

In this background, the present disclosure aims to provide a parking control apparatus and method for selecting a final parking space by determining parking spaces in a parking area where a vehicle is located at present through parking area map information and evaluating each available parking space.

In order to achieve the aspects described above, an aspect of the present disclosure provides a parking control apparatus including: a reception unit configured to receive parking area map information from a server; an extraction unit configured to extract a candidate parking space list including one or more available parking spaces on the basis of the parking area map information; an available parking space evaluation unit configured to allocate a priority order to each of the available parking spaces included in the candidate parking space list on the basis of preset priority order allocation condition information; and a parking space determination unit configured to determine a target parking space for the subject vehicle on the basis of information on priority orders allocated to respective available parking spaces.

Another aspect of the present disclosure provides a parking control method including: receiving parking area map information from a server; extracting a candidate parking space list including one or more available parking spaces on the basis of the parking area map information; allocating a priority order to each of the available parking spaces included in the candidate parking space list on the basis of preset priority order allocation condition information; and determining a target parking space for a subject vehicle on the basis of priority order information allocated to each available parking space.

In a still another aspect, a parking control system of the present disclosure includes: an image sensor capable of being disposed in a vehicle so as to have a field of view of the exterior of the vehicle, the image sensor configured to capture image data; a controller including a processor operable to process the image data captured by the image sensor; and a communication unit configured to communicate with at least one of the controller and the server, in which the communication unit receives parking area map information from the server, and in which the controller includes an extraction unit configured to extract a candidate parking space list including one or more available parking spaces on the basis of the parking area map information; an available parking space evaluation unit configured to allocate a priority order to each of the available parking spaces included in the candidate parking space list on the basis of preset priority order allocation condition information; and a parking space determination unit configured to determine a target parking space for a subject vehicle on the basis of information on the priority order allocated to each available parking space.

In a still another aspect, a parking control system of the present disclosure includes: an image sensor capable of being disposed in a vehicle so as to have a field of view of the exterior of the vehicle, the image sensor configured to capture image data; a non-image sensor disposed on the vehicle so as to sense the exterior of the vehicle, the non-image sensor configured to capture sensing data; a controller including at least one processor configured to process at least one of the image data captured by the image sensor and the sensing data captured by the non-image sensor; and a communication unit configured to communicate with at least one of the controller and the server, in which the communication unit receives parking area map information from the server, and the controller includes: an extraction unit configured to extract a candidate parking space list including one or more available parking spaces on the basis of the parking area map information; an available parking space evaluation unit configured to allocate a priority order to each of the available parking spaces included in the candidate parking space list on the basis of preset priority order allocation condition information; and a parking space determination unit configured to determine a target parking space for a subject vehicle on the basis of priority order information allocated to each of the available parking spaces.

In a yet another aspect, a parking control system of the present disclosure includes: an image sensor capable of being disposed on a vehicle so as to have a field of view of the exterior of the vehicle, the image sensor configured to capture image data; a non-image sensor disposed in the vehicle so as to sense the exterior of the vehicle, the non-image sensor configured to capture sensing data; a domain control unit configured to process at least one of the image data captured by the image sensor and the sensing data captured by the non-image sensor; and a communication unit configured to communicate with at least one of the domain control unit and the server, in which communication unit receives parking area map information from the server, the domain control unit extracts a candidate parking space list including one or more available parking spaces on the basis of the parking area map information, allocates a priority order to each of the available parking spaces included in the candidate parking space list on the basis of preset priority order allocation condition information, and determines a target parking space for a subject vehicle on the basis of priority order information allocated to each available parking space.

As described above, according to the present disclosure, a vehicle is capable of determining an optimum parking space by acquiring information on parking spaces through parking area map information and evaluating each of the parking spaces using spatial characteristics of the parking area without needing to directly access the respective parking spaces of the parking area where the vehicle is located at present so as to compare the respective parking spaces. Accordingly, it is possible to reduce space and time for determining the parking space, and to improve the efficiency of the automatic parking system.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating the configuration of a parking control apparatus according to an embodiment of the present disclosure;

FIG. 2 is a diagram for explaining parking area map information according to an embodiment of the present disclosure;

FIG. 3 is a diagram for explaining a parking space matrix mapped one-to-one to respective parking spaces according to an embodiment of the present disclosure;

FIG. 4 is a diagram for explaining priority order allocation condition information items according to an embodiment of the present disclosure;

FIG. 5 is a score table according to a moving distance to a parking space in an embodiment of the present disclosure;

FIG. 6 is a score table according to a moving distance to an exit in an embodiment of the present disclosure;

FIG. 7 is a score table according to whether or not a surrounding parking space is occupied by a vehicle in an embodiment of the present disclosure;

FIG. 8 is a table of weights allocated to respective priority order allocation condition information items according to an embodiment of the present disclosure;

FIG. 9 is a diagram for explaining a priority order allocated to each available parking space according to an embodiment of the present disclosure;

FIG. 10 is a diagram for explaining a process of a parking space determining unit configured to change a target parking space when it is determined that parking is not possible in the target parking space in an embodiment of the present disclosure;

FIG. 11 is a diagram for explaining an automatic parking method according to an embodiment of the present disclosure;

FIG. 12 is a diagram for explaining a parking control method according to an embodiment of the present disclosure; and

FIG. 13 is a diagram illustrating a parking control system according to one embodiment of the present disclosure.

### DETAILED DESCRIPTION OF THE EXEMPLARY EMBODIMENTS

The present disclosure discloses a parking control apparatus and method.

Hereinafter, embodiments of the present disclosure will be described in detail with reference to the accompanying drawings. In the description of the elements of the present disclosure, terms “first”, “second”, “A”, “B”, “(a)”, “(b)” and the like may be used. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

A “parking area” described in the present disclosure means a place where vehicles can be parked, and provides sections for parking vehicles. For example, the parking area may be a parking lot. A “parking space” indicates a section where one vehicle can be parked within the parking area, and an “available parking space” indicates a parking space not occupied by a vehicle among the parking spaces.

A parking control apparatus in the present disclosure means a control unit for controlling a parking assist function for assisting the parking of a vehicle or for controlling an automatic parking function for allowing a vehicle to perform parking by itself. For example, the parking control apparatus may mean a Main Control Unit (MCU), an Electronic Control Unit (ECU) or a CPU of the vehicle, or may mean a unit having some of the functions of the MCU or the CPU. The functions performed by the parking control apparatus may include at least one of parking space detection, determination as to whether or not parking is available, steering control for entry of the vehicle into a parking space, and vehicle speed control.

Hereinafter, a parking control apparatus and method of the present disclosure will be described in detail by way of example with reference to the drawings.

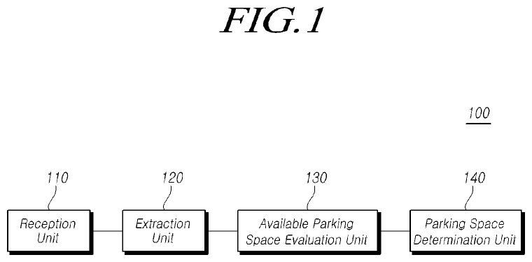

FIG. 1 is a diagram illustrating the configuration of a parking control apparatus according to an embodiment of the present disclosure.

The present disclosure provides a parking control apparatus including: a reception unit configured to receive parking area map information from a server; an extraction unit configured to extract a candidate parking space list including an available parking space on the basis of the parking area map information; an available parking space evaluation unit configured to allocate a priority order to each of one or more available parking spaces included in the candidate parking space list on the basis of preset priority order allocation condition information; and a parking space determination unit configured to determine a target parking space for a subject vehicle on the basis of information on the priority order allocated to each available parking space.

Referring to FIG. 1, a parking control apparatus 100 of the present disclosure includes a reception unit 110 configured to receive parking area map information and/or vehicle position information from a server. The reception unit 110 may be a vehicle-to-everything (V2X) communication module or a position information module.

The V2X communication module is a module configured to perform wireless communication with a server or other vehicles. The V2X module includes a module capable of implementing an inter-vehicle (V2V) communication protocol or a vehicle-to-infrastructure (V2I) communication protocol. A vehicle is capable of performing wireless communication with an external server and other vehicles through the V2X communication module.

For example, the vehicles connected with each other in a vehicle-to-vehicle (V2V) telematic system and a vehicle-to-infrastructure (V2I) telematics system interact with each other in a V2V, V2I, or V2X relation, for example, via wireless communication. Through 3G/4G cellular communication, Wi-Fi communication, 5.9 GHz Dedicated Short-Range Communication (DSRC), and the like may be used in order to help or provide contextual awareness, collision avoidance, and post-accident assistance for vehicle drivers on the road. Such a V2V or V2X communication system is capable of wirelessly transmitting data from a host vehicle equipped with such a system to another vehicle or an automotive and/or an infrastructure system (e.g., a traffic light control system or a traffic management system) using telematics. The data may be delivered to the host vehicle from other vehicles and/or infrastructure systems in the manner of telematics. Such data may include parking map information, traffic situation data, traffic density data, weather data, road condition data, and so on.

The position information module is a module for acquiring position information of a vehicle, and a representative example thereof is a Global Positioning System (GPS) module. For example, when a vehicle utilizes a GPS module, it is possible to acquire the position of the vehicle using a signal sent from a GPS satellite.

The reception unit 110 may specify the current position of the subject vehicle and receive the parking area map information from the server, or may receive the parking area map information from the server when the subject vehicle is positioned in a specific position range within the parking area where the subject vehicle is capable of communicating with the server. The reception unit 110 is capable of receiving the parking area map information from the server through V2I communication. The parking area map information provides spatial information of a parking area, and represents real-time state information of a parking space in a parking area. The parking area map information may include position information of the subject vehicle in the parking area, position information of the parking space, road information of the parking area, position information of an entrance in the parking area, information as to whether a parking space is occupied by a vehicle, and so on.

In addition, the parking control apparatus 100 includes an extraction unit 120 configured to extract a candidate parking space list including an available parking space on the basis of the parking area map information. As described above, an available parking space is a parking space not occupied by a vehicle among the parking spaces existing in the parking area, and means a space where the parking of the subject vehicle can be performed. The extraction unit 120 may extract a candidate parking space list including available parking space information using parking space position information in a parking area included in the parking area map information and information on whether or not a parking space is occupied by a vehicle.

When extracting the candidate parking space list including an available parking space, the extraction unit 120 may use a parking space matrix mapped one-to-one to respective parking spaces in the parking area. The parking space matrix includes information on a parking space where parking is available (available parking space) and information on a parking space where parking is not available by being parked by another vehicle (non-available parking space).

For example, the extraction unit 120 may generate a parking space matrix mapped one-to-one to respective parking spaces on the basis of the parking area map information, and may extract a candidate parking space list including an available parking space on the basis of the generated parking space matrix.

As another example, the parking area map information received from the server may include a parking space matrix mapped one-to-one to respective parking spaces, and the extraction unit 120 may extract a candidate parking space list including an available parking space on the basis of the parking space matrix.

In the parking space matrix, matrix elements one-to-one mapped to the available parking spaces and the non-available parking spaces in the parking space within the parking space may be indicated using different symbols or numbers. For example, in the parking space matrix, with respect to the elements of the mapped parking space, available parking spaces may be indicated as 0 and non-available parking spaces may be indicated as 1.

The candidate parking space list includes information on available parking spaces in the parking area. The available parking spaces included in the candidate parking space list may be indicated by the coordinates of cells indicated as available parking spaces in the parking space matrix.

The parking control apparatus 100 includes an available parking space evaluation unit 130 configured to allocate a priority order to each of the available parking spaces included in the candidate parking space list on the basis of preset priority order allocation condition information. The available parking space evaluation unit 130 may allocate a priority order to each available parking space by performing evaluation of priority order allocation condition information items and applying weight values, which have been set for respective pieces of priority order allocation condition information, to the evaluation results.

Here, the priority order allocation condition information items include at least one of moving distance information from the subject vehicle to the corresponding available parking space, distance information from the corresponding available parking space to an entrance, and information on whether or not surrounding parking spaces of the available parking space are occupied by vehicles. The moving distance from the subject vehicle to the available parking space indicates the distance of the shortest moving route from the position of the subject vehicle to the corresponding parking space on the parking area map. Here, the position of the subject vehicle may be the position of the subject vehicle determined in order to receive the parking area map information or the position of the subject vehicle indicated in the parking area map information. The distance information from the corresponding available parking space to the entrance indicates the distance of the shortest moving route from the corresponding available parking space to the entrance. The information on the surrounding parking spaces of the available parking space indicates information on whether the left and right parking spaces of the corresponding parking space are occupied by other vehicles.

With regard to evaluating the priority order allocation condition information items for each available parking space, the available parking evaluation unit 130 extracts information corresponding to individual items of the priority order allocation condition information with respect to each available parking space, and converts the information on the extracted individual items into a score according to a predetermined score table to determine the score of each priority order allocation condition information item for each available parking space. For example, with respect to each available parking space, the available parking space evaluation unit 130 extracts moving distance information from the subject vehicle to the available parking space, distance information from the corresponding available parking space to the entrance, and information on whether or not surrounding parking spaces of the corresponding available parking space are occupied by vehicles. Then, the available parking space evaluation unit 130 determines scores of the extracted moving distance information from the subject vehicle to the available parking space, distance information from the corresponding available parking space to the entrance, and information on whether or not surrounding parking spaces of the corresponding available parking spaces are occupied by vehicles are extracted according to the score tables of respective priority order allocation condition information items.

With regard to allocating a priority order by applying a weight set for each priority order allocation condition information to an evaluation result, the available parking space evaluation unit 130 may calculate the weight values of respective priority order allocation condition information items by multiplying the scores of respective priority order allocation condition information items for respective available parking spaces by weights set for respective priority order allocation condition information, may calculate parking space scores for respective available parking spaces by summing weight values of the priority order allocation condition items of respective available parking spaces, and may allocate priority orders of respective available parking spaces in the descending order of the calculated parking space scores. Weights of priority order allocation condition information may be set to previously stored default values or may be determined by user's setting signals.

The parking control apparatus 100 includes a parking space determination unit 140 configured to determine a target parking space for the subject vehicle on the basis of the priority order information allocated to each available parking space. The parking space determination unit 140 may determine the available parking space having the highest priority order as the target parking space for the subject vehicle.

When it is determined that it is impossible to park the subject vehicle in the target parking space, the parking space determination unit 140 may determine the available parking space to which the next priority order is allocated as the target parking space. For example, when it is determined that it is impossible to park the subject vehicle in the determined target parking space since an obstacle such as freight are present in the determined target parking space or a part of the target parking space even though the target parking space is not occupied by another vehicle, the parking space determination unit 140 may determine the target parking space having the next priority order as the target parking space.

The parking control apparatus according to the present disclosure extracts a candidate parking space list on the basis of the parking area map information received from the server, allocates priority orders on the basis of the priority order allocation condition information to respective available parking spaces included in the candidate parking space list, and determines a target parking space on the basis of the priority orders. In order to determine a parking space, the vehicle is capable of determining an optimum parking space by acquiring parking space information through the parking area map information and comparing the respective parking spaces using the spatial characteristics of the parking area without needing to directly access each parking space of the parking area. Accordingly, it is possible to reduce space and time for determining the parking space, and to improve the efficiency of the automatic parking system.

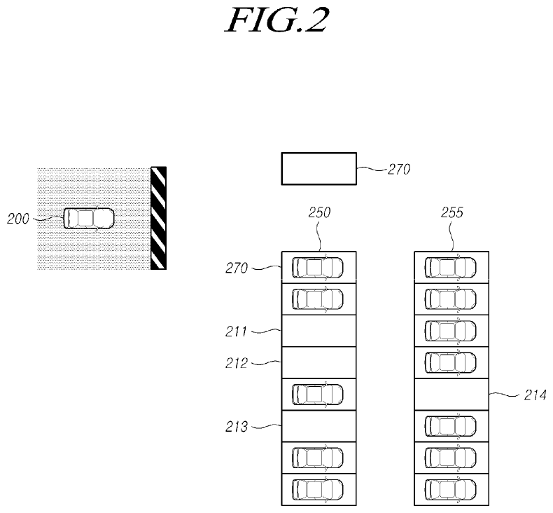

FIG. 2 is a diagram for explaining parking area map information according to an embodiment of the present disclosure.

Referring to FIG. 2, the reception unit 110 of the parking control apparatus 100 receives parking area map information from a server. At this time, the position information of a subject vehicle 200 is specified and indicated in the parking area map information. The arrangement information and road information of parking spaces 250 and 255 may be acquired from the parking area map information. Furthermore, the position information of an entrance 270 in the parking area may also be indicated. The parking area map information includes information on whether or not respective parking spaces are occupied by vehicles, and the reception unit 110 may receive a change in the occupancy state of each parking space in real time. In FIG. 2, parking spaces in which a vehicle exists, such as the parking space 270, in the parking spaces 250 and 255, indicate parking spaces occupied by other vehicles. Unlike this, parking spaces 211, 212, 213, and 214 in which no vehicle exists indicate available parking spaces that are not occupied by the other vehicles.

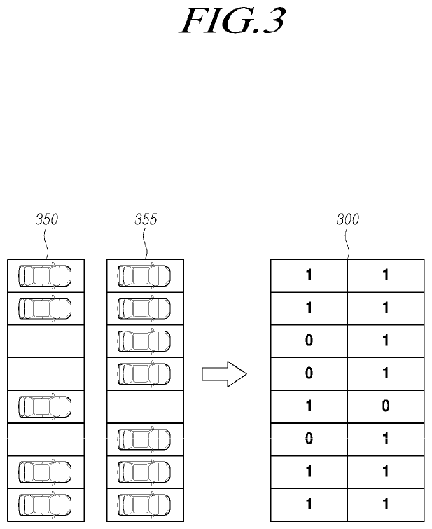

FIG. 3 is a diagram for explaining a parking space matrix 300 mapped one-to-one to respective parking spaces according to an embodiment of the present disclosure.

When extracting the candidate parking space list including an available parking space, the extraction unit 120 of the parking control apparatus 100 may use a parking space matrix 300 mapped one-to-one to respective parking spaces in the parking area. The parking space matrix 300 mapped one-to-one to respective parking spaces on the basis of the parking area map information may be generated by the extraction unit 120 of the parking control device 100 or may be included in the parking area map information received from the server.

Referring to FIG. 3, the vehicle occupancy state information of the parking spaces 350 and 355 is mapped one-to-one to respective parking spaces as in the parking space matrix 300 shown in FIG. 3. In the parking space matrix 300, elements of a matrix that are mapped one-to-one to available parking spaces and non-available parking spaces occupied by other vehicles in the parking spaces 350 and 355 of a parking area in a space may be indicated using different symbols or numbers. For example, in FIG. 3, in the parking space matrix 300, the elements of the mapped parking spaces for available parking spaces are indicated as 0, and the elements for non-available parking spaces are indicated as 1.

The extraction unit 120 of the parking control apparatus 100 extracts a candidate parking space list including available parking spaces on the basis of the parking space matrix 300. Here, the available parking spaces may be indicated by coordinates of cells indicated as available parking spaces in the parking space matrix 300. For example, the candidate parking space list extracted in FIG. 3 is {(3, 1), (4, 1), (5, 2), (6, 1)}.

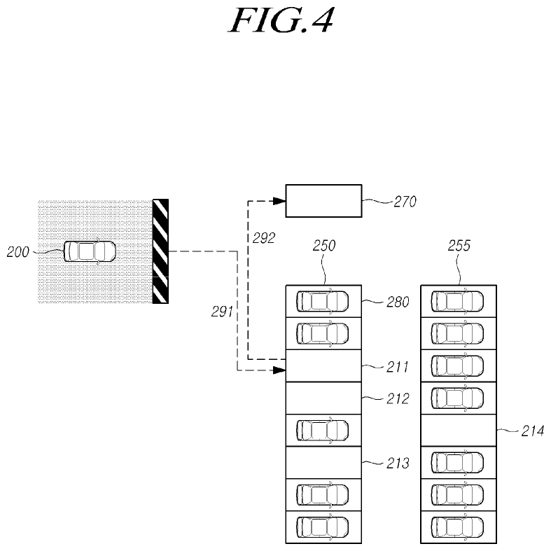

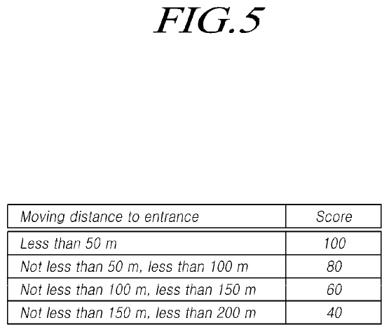

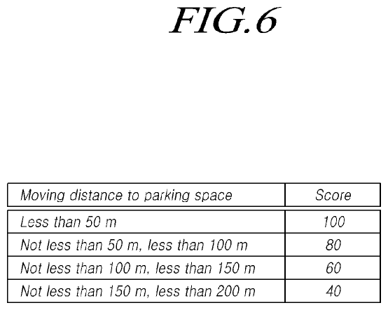

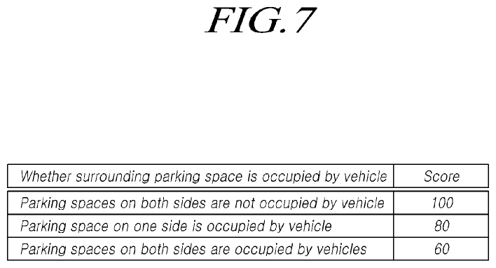

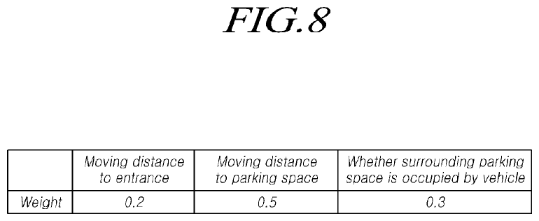

FIG. 4 is a diagram for explaining priority order allocation condition information items according to an embodiment of the present disclosure, and FIGS. 5 to 7 are score tables of respective priority order allocation condition information items according to an embodiment of the present disclosure. In addition, FIG. 8 is a table of weights allocated to respective priority order allocation condition information items according to an embodiment of the present disclosure. Hereinafter, a specific evaluation process of the available parking space evaluation unit 130 of the parking control apparatus 100 will be described in detail by way of example.

The available parking space evaluation unit 130 of the parking control apparatus 100 allocates a priority order to each of available parking spaces included in the candidate parking space list on the basis of preset priority order allocation condition information. Here, the priority order allocation condition information items include at least one of moving distance information from the subject vehicle to the corresponding available parking space, distance information from the corresponding available parking space to an entrance, and information on whether or not surrounding parking spaces of the available parking space are occupied by a vehicle.

According to an embodiment of the present disclosure, the available parking space evaluation unit 130 of the parking control apparatus 100 allocates a priority order to each available parking space by performing evaluation of priority order allocation condition information items and applying weight values, which have been set for respective pieces of priority order allocation condition information, to the evaluation results.

Specifically, with regard to evaluating the priority order allocation condition information items for each available parking space, the available parking evaluation unit 130 extracts information corresponding to individual items of the priority order allocation condition information with respect to each available parking space, and converts the information on the extracted individual items into a score according to a predetermined score table to determine the score of each priority order allocation condition information item for each available parking space.

For example, with respect to each available parking space, the available parking space evaluation unit 130 extracts moving distance information from the subject vehicle to the available parking space, distance information from the corresponding available parking space to the entrance, and information on whether or not surrounding parking spaces of the corresponding available parking space are occupied by vehicles.

Referring to FIG. 4, the process of extracting the priority order allocation condition information for an available parking space 211 will be described. A moving distance 291 from the subject vehicle to the available parking space may be extracted by measuring the distance of the shortest moving route from the position of the subject vehicle 200 to the corresponding available parking space 211. Here, the position of the subject vehicle 200 may be the position of the subject vehicle indicated in the parking area map information. The distance 292 from the corresponding available parking space 211 to the entrance may be extracted by measuring the distance of the shortest moving route from the corresponding available parking space 211 to an entrance 270. The parking status information of the surrounding parking spaces of the available parking space is information on whether the left and right parking spaces of the corresponding available parking space 211 are occupied by other vehicles, and may be extracted from the parking area map information.

Then, the available parking space evaluation unit 130 may determine scores of the extracted moving distance information from the subject vehicle to the available parking space, distance information from the corresponding available parking space to the entrance, and information on whether or not surrounding parking spaces of the corresponding available parking spaces are occupied by vehicles are determined according to the score tables of respective priority order allocation condition information items.

For example, FIGS. 5 to 7 show score tables of respective priority order allocation condition information items. It should be noted that the score tables of respective priority order allocation condition information items are not limited thereto and may be changed depending on actual application conditions.

The priority order allocation condition information for the available parking space 211 in FIG. 4 is converted into scores according to the score tables of FIGS. 5 to 7 as follows.

For example, when the moving distance 291 from the the subject vehicle 200 to the available parking space 211 is 40 m, the distance 292 from the corresponding available parking space 211 to the entrance 270 is 55 m, the vehicle occupation state of the surrounding parking spaces of the corresponding available parking space 211 is that only parking space at one side of the available parking space 211 is occupied by a vehicle. In this case, according to the score tables of priority order allocation condition information in FIGS. 5 to 7, the score of the moving distance from the subject vehicle to the available parking space is 100, the score of the distance from the corresponding available parking space to the entrance is 80, and the score of the occupancy state of the surrounding parking spaces of the corresponding available parking space is 80.

Then, with respect to allocating priority orders by applying the weights set for each priority order allocation condition information to an evaluation result, the available parking evaluation unit 130 calculates a weight value of each priority order allocation condition information item for each available parking space by multiplying the score of each priority order allocation condition information item for each available parking space by the weight set for each priority order allocation condition information. Here, the weights of priority order allocation condition information may be set to previously stored default values or may be determined by user's setting signals. Then, the parking space score of the available parking space is calculated by summing the weight values of the priority order allocation condition information items of the available parking space.

FIG. 8 shows an example of weights given to priority order allocation condition information items. According to the table of FIG. 8, a weight given to moving distance information from the subject vehicle to an available parking space is 0.2, a weight given to distance information from an available parking space to an entrance is 0.5, and a weight given to information as to whether surrounding parking spaces of the corresponding available parking space is 0.3. However, the table of weights of FIG. 8 is merely an embodiment of the present disclosure, and the present disclosure is not limited thereto.

Upon using the table of weights of FIG. 8, the weight values of respective priority order allocation condition information for the available parking space 211 of FIG. 4 are as follows.

First, the weight value of the moving distance from the subject vehicle to the available parking space is 100×0.2=20, the weight value of the distance from the corresponding available parking space to the entrance is 80×0.5=40, and the weight value of the occupancy state of the surrounding parking spaces of the available parking space is 80×0.3=24. When summing the weight values of the respective priority order allocation condition information for the available parking space 211, the parking space score of the available parking space 211 is 84 (=20+40+24).

In this way, the parking space scores for the remaining available parking spaces in the parking area are calculated. As a result, the evaluation of respective available parking spaces may be performed on the basis of the parking space scores.

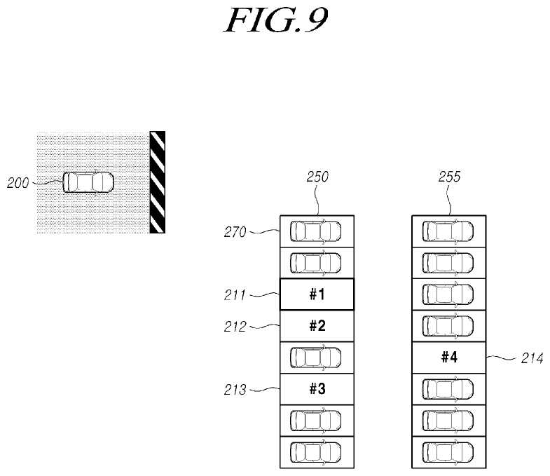

FIG. 9 is a diagram for explaining priority order allocated to each available parking space according to an embodiment of the present disclosure.

When calculating the parking space scores for available parking spaces in the parking area in the manner described above, the parking space evaluation unit 130 allocates priority orders to respective available parking spaces. The priority orders of respective available parking spaces may be allocated in descending order of the calculated parking space scores. Referring to FIG. 9, the available parking space 211 has the highest priority (#1), and the available parking space 212, the available parking space 213, and the available parking space 214 have a high priority order in this order.

The parking space determination unit 140 of the parking control apparatus 100 determines a target parking space for the subject vehicle on the basis of the priority order information allocated to each available parking space. The parking space determination unit 140 may determine the available parking space having the highest priority order as the target parking space for the subject vehicle. In the example of FIG. 9, the parking space determination unit 140 determines the available parking space 211 having the highest priority order as the target parking space.

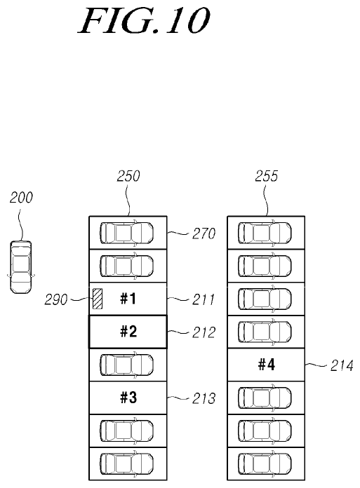

FIG. 10 is a diagram for explaining a process of a parking space determining unit configured to change a target parking space when it is determined that parking is not possible in the target parking space in an embodiment of the present disclosure.

When it is determined that it is impossible to park the subject vehicle in the target parking space, the parking space determination unit 140 of the parking control apparatus 100 may determine the available parking space to which the next priority order is allocated as the target parking space. For example, when it is determined that it is impossible to park the subject vehicle in the determined target parking space since an obstacle 290 such as freight is present in the determined target parking space or a part of the target parking space even though the target parking space is not occupied by another vehicle, the parking space determination unit 140 may determine the available parking space having the next priority order as the target parking space. Referring to FIG. 10, when the parking control device 100 determines that it is impossible to park the subject vehicle in the determined target parking space 211 due to the obstacle 290 or the like, the parking space determination unit 140 may determine the available parking space 212 having the next priority order as the target parking space.

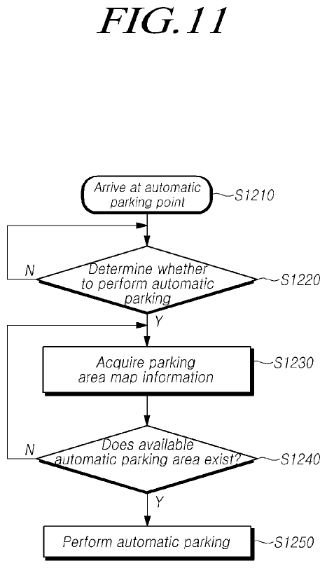

FIG. 11 is a diagram for explaining an automatic parking method according to an embodiment of the present disclosure.

When the vehicle arrives at a point where automatic parking is to be performed (S1210), it is determined whether to perform the automatic parking (S1220). It may be determined to perform automatic parking by receiving an instruction signal for performing automatic parking from the user. Alternatively, it may be determined to perform automatic parking when the subject vehicle is located at a specific position in the parking area. When it is determined to perform automatic parking, the parking area map information is acquired from a server (S1230). This parking area map information acquisition step corresponds to the function of the reception unit 110 of the parking control apparatus 100 described above. Thereafter, it is determined whether or not an available parking space exists (S1240). With regard to detailed processes, reference may be made to the specific processes performed by the extraction unit 120 and the available parking space evaluation unit 130 of the parking control apparatus 100 described above. When available parking spaces exist, one of the available parking spaces is determined as the target parking space, and automatic parking is performed (S1250).

When performing the automatic parking, at least one of information on a vehicle position state, information on an object existing in the vicinity of the vehicle, and the information on other surrounding environments of the vehicle may be used. The peripheral information of the vehicle may be captured or sensed using one or more sensors mounted on the vehicle. Here, the one or more sensors may include an image sensor and a non-image sensor.

The image sensor may be a camera, an image system, or a vehicle image sensor represented by a vision system. Such a vehicle image sensor may include a front camera having a field of view directed to the front side of the vehicle, a rear camera having a field of view directed to the rear side of the vehicle, and a rear lateral side camera having a field of view directed to a lateral side or rear lateral side of the vehicle, and in some case, at least one of the directional cameras described above may be selectively included.

The cameras perform the function of capturing the image data of the surroundings of the vehicle and transmitting the data to a processor or a controller. A vision system or an image sensor according to an embodiment may further include an ECU or an image processor having functions of processing the captured image data and indicating the processed data on a display or the like. The image data captured by the image sensor or a camera may be generated in a format of Raw-type AVI, MPEG-4, H.264, DivX, or JPEG, for example.

In addition, the vision system, the image sensor, or the like in an embodiment may further include an appropriate data link or communication link such as a vehicle network bus for signal communication or data transmission to the image processor from the camera.

Further, the vehicle to which the present embodiment is applied may further include a non-image sensor such as a radar sensor or an ultrasonic sensor.

Such a non-image sensor is disposed on the vehicle so as to function to capture sensing data for sensing one of surrounding objects of the vehicle, and means an additional sensor other than an image sensor that captures an image. Examples of non-image sensors include a radar sensor, a lidar sensor, an ultrasonic sensor, and the like. Specifically, the non-image sensor means a sensor that transmits electromagnetic waves such as radar waves or ultrasonic waves and receives and analyzes a signal reflected from a target object, thereby calculating information such as a distance to the target object and a position.

The vehicle may perform the automatic parking after recognizing the surroundings thereof using at least one of the sensors described above. The mechanism related to the control technology such as the detection of the parking space related to the automatic parking, the determination on whether the parking is available, and the steering control and the vehicle speed control for the entrance of the vehicle into a parking space may utilize conventional automatic parking techniques, which are well known to those ordinarily skilled in the art. Thus, the mechanism is not specifically described herein.

With regard to the specific process of determining the target parking space, reference may be made to the specific processes performed by the parking space determination unit 140 of the parking control device 100 described above. When no available parking space exists, after waiting for a certain period of time, the parking area map information may be updated again so as to determine whether an available parking space exists. Alternatively, the vehicle may be moved to another floor of the parking area, the parking area map information of the corresponding floor may be acquired, and then it may be determined whether or not an available parking space exists.

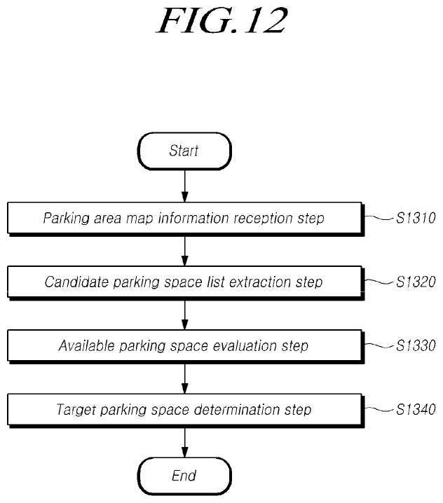

FIG. 12 is a diagram for explaining a parking control method according to an embodiment of the present disclosure.

The present disclosure provides a parking control method including: receiving parking area map information from a server; extracting a candidate parking space list including available parking spaces on the basis of the parking area map information; allocating a priority order to each of the available parking spaces included in the candidate parking space list on the basis of preset priority order allocation condition information; and determining a target parking space for the subject vehicle on the basis of information on the priority order allocated to each available parking space.

Referring to FIG. 12, the parking control method of the present disclosure includes a reception step of receiving parking area map information from a server (S1310). In the reception step, the current position of the subject vehicle may be specified and the parking area map information may be received from the server, or the reception step may be performed when the subject vehicle is positioned in a specific position range within the parking area where the subject vehicle is capable of communicating with the server. In the reception step, the parking area map information may be received from the server through V2I communication. The parking area map information provides spatial information of a parking area, and represents real-time state information of a parking space in a parking area. The parking area map information may include position information of the subject vehicle in the parking area, position information of the parking space, road information of the parking area, position information of an entrance in the parking area, information as to whether a parking space is occupied by a vehicle, and so on.

In addition, the parking control method includes a step of extracting a candidate parking space list including an available parking space on the basis of the parking area map information (S1320). As described above, an available parking space is a parking space not occupied by a vehicle among the parking spaces existing in the parking area, and means a space where the parking of the subject vehicle can be performed. In the extraction step, a candidate parking space list including available parking space information may be extracted using parking space position information in a parking area included in the parking area map information and information on whether or not a parking space is occupied by a vehicle.

In the extraction step, a parking space matrix mapped one-to-one to respective parking spaces in the parking area may be used when extracting the candidate parking space list including an available parking space. The parking space matrix includes information on a parking space where parking is available (available parking space) and information on a parking space where parking is not available by being parked by another vehicle (non-available parking space).

For example, in the extraction step, a parking space matrix mapped one-to-one to respective parking spaces on the basis of the parking area map information may be generated, and a candidate parking space list including an available parking space may be extracted on the basis of the generated parking space matrix.

As another example, the parking area map information received from the server may include a parking space matrix mapped one-to-one to respective parking spaces, and in the extraction step, a candidate parking space list including an available parking space may be extracted on the basis of the parking space matrix.

The parking space matrix may indicate elements of the one-to-one mapped matrix of available parking spaces and the non-available parking spaces in the parking space within the parking area with different symbols or numbers. For example, with respect to the elements of the mapped parking space, in the parking space matrix, available parking spaces may be indicated as 0 and non-available parking spaces may be indicated as 1.

The candidate parking space list includes information on available parking spaces in the parking area. The available parking spaces included in the candidate parking space list may be indicated by the coordinates of cells indicated as available parking spaces in the parking space matrix.

The parking control method includes an available parking space evaluation step of allocating a priority order to each of one or more available parking spaces included in the candidate parking space list on the basis of preset priority order allocation condition information (S1330). In the available parking space evaluation step, a priority order may be allocated to each available parking space by performing evaluation of priority order allocation condition information items for each available parking space and applying a weight, which have been set for each priority order allocation condition information, to an evaluation result.

Here, the priority order allocation condition information items include at least one of moving distance information from the subject vehicle to the corresponding available parking space, distance information from the corresponding available parking space to an entrance, and information on whether or not surrounding parking spaces of the available parking space are occupied by vehicles. The moving distance from the subject vehicle to the available parking space indicates the distance of the shortest moving route from the position of the subject vehicle to the corresponding parking space on the parking area map. Here, the position of the subject vehicle may be the position of the subject vehicle determined in order to receive the parking area map information or the position of the subject vehicle indicated in the parking area map information. The distance information from the corresponding available parking space to the entrance indicates the distance of the shortest moving route from the corresponding available parking space to the entrance. The information on the surrounding parking spaces of the available parking space indicates information on whether the left and right parking spaces of the corresponding parking space are occupied by other vehicles.

With regard to evaluating the priority order allocation condition information items for each available parking space, in the available parking evaluation step, information corresponding to individual items of the priority order allocation condition information with respect to each available parking space is extracted, and the information on the extracted individual items is converted into a score according to a predetermined score table so as to determine the score of each priority order allocation condition information item for each available parking space. For example, with respect to each available parking space, in the available parking space evaluation step, moving distance information from the subject vehicle to the available parking space, distance information from the corresponding available parking space to the entrance, and information on whether or not surrounding parking spaces of the corresponding available parking space are occupied by vehicles are extracted. Then, the available parking space evaluation unit 130 determines scores of the extracted moving distance information from the subject vehicle to the available parking space, distance information from the corresponding available parking space to the entrance, and information on whether or not surrounding parking spaces of the corresponding available parking spaces are occupied by vehicles are extracted according to the score tables of respective priority order allocation condition information items.

With regard to allocating a priority order by applying a weight set for each priority order allocation condition information to an evaluation result, in the available parking space evaluation step, the weight values of respective priority order allocation condition information items for respective available parking spaces are calculated by multiplying the scores of respective priority order allocation condition information items for respective available parking spaces by weights set for respective priority order allocation condition information, parking space scores of respective available parking spaces are calculated by summing weight values of the priority order allocation condition items of the respective available parking spaces, and priority orders of respective available parking spaces may be allocated in the descending order of the calculated parking space scores. Weights of priority order allocation condition information may be set to previously stored default values or may be determined by user's setting signals.

The parking control method includes a step of determining a target parking space for the subject vehicle on the basis of information on the priority order allocated to each available parking space (S1340). In the parking space determination step, the available parking space having the highest priority order may be determined as the target parking space for the subject vehicle.

When it is determined that it is impossible to park the subject vehicle in the target parking space, in the parking space determination step, the available parking space to which the next priority order is allocated may be determined as the target parking space. For example, when it is determined that it is impossible to park the subject vehicle in the determined target parking space since an obstacle such as freight are present in the determined target parking space or a part of the target parking space even though the target parking space is not occupied by another vehicle, in the parking space determination step, the available parking space having the next priority order may be determined as the target parking space.

In the parking control method according to the present disclosure, a candidate parking space list is extracted on the basis of the parking area map information received from the server, priority orders are allocated on the basis of the priority order allocation condition information to respective available parking spaces included in the candidate parking space list, and a target parking space is determined on the basis of the priority orders. In order to determine a parking space, the vehicle is capable of determining an optimum parking space by acquiring parking space information through the parking area map information and comparing the respective parking spaces using the spatial characteristics of the parking area without needing to directly access each parking space of the parking area. Accordingly, it is possible to reduce space and time for determining the parking space, and to improve the efficiency of the automatic parking system.

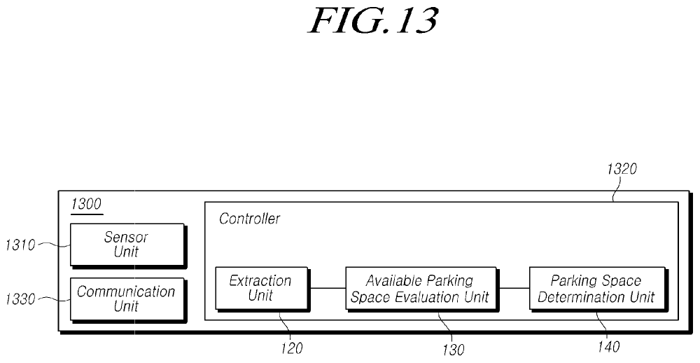

FIG. 13 is a diagram illustrating a parking control system according to one embodiment of the present disclosure. A parking control system of the present disclosure may include: a sensor unit 1310 mounted on a vehicle and configured to capture or sense a surrounding environment of the vehicle; a communication unit 1330 capable of communicating with another device, a system, or a server, the communication unit 1330 being configured to receive parking area map information from the server; a controller 1320 configured to: extract a candidate parking space list including available parking spaces on the basis of the parking area map information received from the communication unit; allocate a priority order to each of the available parking spaces included in the candidate parking space list on the basis of preset priority order allocation condition information; and determine a target parking space for the subject vehicle on the basis of information on the priority order allocated to each available parking space.

The sensor unit 1310 of the present embodiment may include at least one of an image sensor and a non-image sensor. For the detailed description of the image sensor and the non-image sensor, reference may be made the description of the image sensor and the non-image sensor described above with reference to FIG. 11.

The communication unit 1330 of the present embodiment may include a V2X communication module and/or a location information module. For the detailed description of the V2X communication module and the position information module, reference may be made to the description of the V2X communication module and the position information module described above with reference to FIG. 1.

The functions of the above-described controller 1320 are the same as the functions of respective components of the parking control apparatus described above with reference to FIG. 1, more specifically the extraction unit 120, the parking space evaluation unit 130, and the parking space determination unit 140.

In addition, the controller 1320 of the present embodiment may function as a controller that integrates the extraction unit 120, the available parking space evaluation unit 130, and the parking space determination unit 140.

The controller 1320 of the present embodiment may include at least one processor configured to process the data captured or sensed by the sensor unit 1310. The controller is configured to receive the processing result of the captured image data from the processor, and to receive the captured sensing data from the plurality of non-image sensors so as to process at least one of the image data or the sensing data. Further, the controller is configured to receive or acquire the parking area map information received from the server from the communication unit.

The controller is operable to: extract a candidate parking space list including available parking spaces, responsive at least in part to processing of the parking area map information received from the server and the image data captured by the image sensor; allocate a priority order to each of the available parking spaces included in the candidate parking space list on the basis of preset priority order allocation condition information; and determine a target parking space for the subject vehicle on the basis of information on the priority order allocated to each available parking space.

In addition, the controller according to the present embodiment may be implemented with a Domain Control Unit (DCU) integrally having a function of receiving and processing information of various vehicle sensors or relaying the transmission and reception of sensor signals, and a function of performing evaluation of available parking spaces on the basis of the parking area map information according to the present embodiment and determining an optimal parking space. However, the present disclosure is not limited thereto.

Such a DCU is operable to: process at least one of the image data captured by the image sensor and the sensing data captured by the non-image sensor; extract a candidate parking space list including available parking spaces, responsive at least in part to processing of the image data captured by the image sensor and processing of the sensing data captured by the non-image sensor, and on the basis of the parking area map information received from the communication unit; allocate a priority order to each of the available parking spaces included in the candidate parking space list on the basis of preset priority order allocation condition information; and determine a target parking space for the subject vehicle on the basis of the priority order information assigned to each available parking space.

The DCU may be operable to control one or more of various DASs used in the vehicle. For example, the DCU may determine occurrence of a certain situation, a condition or an event, execution of a control operation, or the like on the basis of data acquired from at least one of the above-described image sensor, non-image sensor, V2X communication module, and position information module.

The DCU may transmit a signal for controlling the operations of various DASs configured inside the vehicle using determined information or the like. For example, the DASs may include a Blind Spot Detection (BSD) system module, a Lane Keeping Assist System (LKAS) module, an Adaptive Smart Cruise Control (ASCC) system module, and the like. In addition, the DASs configured in the vehicle may be variously provided, such as a Lane Departure Warning System (LDWS), a Lane Change Assist System (LCAS), a Parking Assist System (PAS), and the like. The terms and names of the driver assistance systems described herein are illustrative and the present disclosure is not limited thereto. In addition, the driver assistance system may include an autonomous drive module. Alternatively, the DCU may control the vehicle to perform autonomous drive through the control of individual system modules included in the DASs.

The terms “system”, “processor”, “controller”, “component”, “module”, “interface”, “model”, “unit”, and the like described above generally mean computer-related entity hardware, a combination of hardware and software, or software which is being executed. For example, the above-described components may be, but are not limited to, a process driven by a processor, a processor, a controller, a control processor, an entity, an execution thread, a program, and/or a computer. For example, all of an application that is being executed in a controller or a processor and a controller or a processor may be components. One or more components may exist within a process and/or an execution thread, may be positioned in one system or may be distributed to two or more systems.

In addition, since terms, such as “including,” “comprising,” and “having” mean that one or more corresponding components may exist unless they are specifically described to the contrary, it shall be construed that one or more other components can be included. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

The above description and the accompanying drawings provide an example of the technical idea of the present disclosure for illustrative purposes only. Those having ordinary knowledge in the technical field, to which the present disclosure pertains, will appreciate that various modifications and changes in form, such as combination, separation, substitution, and change of a configuration, are possible without departing from the essential features of the present disclosure. Therefore, the embodiments disclosed in the present disclosure are intended to illustrate the scope of the technical idea of the present disclosure, and the scope of the present disclosure is not limited by the embodiment. That is, at least two elements of all structural elements may be selectively joined and operate without departing from the scope of the present disclosure. The scope of the present disclosure shall be construed on the basis of the accompanying claims in such a manner that all of the technical ideas included within the scope equivalent to the claims belong to the present disclosure.

What is claimed is:

1. A parking control apparatus comprising:
a reception unit configured to receive parking area map information from a server;
an extraction unit configured to extract a candidate parking space list comprising one or more available parking spaces based on the parking area map information;
an available parking space evaluation unit configured to allocate a priority order to each of the available parking spaces comprised in the candidate parking space list based on preset priority order allocation condition information; and
a parking space determination unit configured to determine a target parking space for a subject vehicle based on priority order information allocated to each of the available parking spaces.

2. The parking control apparatus of claim 1, wherein the extraction unit generates a parking space matrix mapped one-to-one to respective parking spaces based on the parking area map information, and extracts the candidate parking space list comprising the available parking spaces based on the parking space matrix.

3. The parking control apparatus of claim 1, wherein the received parking area map information comprises a parking space matrix mapped one-to-one to respective parking spaces, and
wherein the extraction unit extracts the candidate parking space list comprising the available parking spaces based on the parking space matrix.

4. The parking control apparatus of claim 1, wherein the available parking space evaluation unit evaluates the priority order allocation condition information item for each available parking space and allocates a priority order to each available parking space by applying a weight, which has been set for each priority order allocation condition information, to an evaluation result.

5. The parking control apparatus of claim 4, wherein the priority order allocation condition information items comprise at least one of moving distance information from the subject vehicle to a corresponding available parking space, distance information from the corresponding available parking space to an entrance, and information on whether or not a surrounding parking space around the available parking space is occupied by a vehicle.

6. The parking control apparatus of claim 4, wherein the weight of priority order allocation condition information is set to a previously stored default value or is determined by a user's setting signal.

7. The parking control apparatus of claim 4, wherein the available parking space evaluation unit extracts information corresponding to individual items of the priority order allocation condition information for each of the available parking spaces, converts the information on the extracted individual items into scores according to a preset score table, and determines a score of each priority order allocation condition information item for each of the available parking spaces.

8. The parking control apparatus of claim 7, wherein the available parking evaluation unit calculates a weight value of each priority order allocation condition information item for each available parking space by multiplying the score of each priority order allocation condition information item for each available parking space by the weight set for each priority order allocation condition information, calculates parking space scores of the available parking spaces by summing the weight values of the priority order allocation condition information items of the available parking spaces, and allocates priority orders of respective available parking spaces in descending order of the calculated parking space scores.

9. The parking control apparatus of claim 8, wherein the parking space determination unit determines an available parking space having a highest priority order as the target parking space for the subject vehicle.

10. The parking control apparatus of claim 4, wherein, when it is determined that it is impossible to park the subject vehicle in the target parking space, in the parking space determination step, the parking space determination unit determines an available parking space to which a next priority order is allocated as the target parking space.

11. A parking control method comprising:
receiving parking area map information from a server;
extracting a candidate parking space list comprising one or more available parking spaces based on the parking area map information;
allocating a priority order to each of the available parking spaces comprised in the candidate parking space list based on preset priority order allocation condition information; and
determining a target parking space for a subject vehicle based on priority order information allocated to each available parking space.

12. The parking control method of claim 11, wherein the allocating of a priority order to each of the available parking spaces comprised in the candidate parking space list based on preset priority order allocation condition information comprises:
evaluating the priority order allocation condition information item for each available parking space; and
allocating a priority order to each available parking space by applying a weight, which has been set for each priority order allocation condition information, to an evaluation result.

13. The parking control method of claim 12, wherein the evaluating of the priority order allocation condition information item for each available parking space comprises:
extracting information corresponding to individual items of the priority order allocation condition information for each of the available parking spaces;
converting the information on the extracted individual items into scores according to a preset score table; and
determining a score of each priority order allocation condition information item for each of the available parking spaces.

14. The parking control method of claim 13, wherein the allocating of a priority order to each available parking space by applying a weight, which has been set for each priority order allocation condition information, to an evaluation result comprises:
calculating a weight value of each priority order allocation condition information item for each available parking space by multiplying the score of each priority order allocation condition information item for each available parking space by the weight set for each priority order allocation condition information;
calculating parking space scores of the available parking spaces by summing the weight values of the priority order allocation condition information items of the available parking spaces; and
allocating priority orders of respective available parking spaces in descending order of the calculated parking space scores.

15. The parking control method of claim 14, wherein the determining of a target parking space for the subject vehicle based on priority order information allocated to each available parking space comprises:
determining an available parking space having a highest priority order as the target parking space for the subject vehicle.

16. A parking control system comprising:
an image sensor capable of being disposed in a vehicle so as to have a field of view of exterior of the vehicle, the image sensor configured to capture image data;
a controller comprising a processor operable to process the image data captured by the image sensor; and
a communication unit configured to communicate with at least one of the controller and the server,
wherein the communication unit receives parking area map information from the server, and
wherein the controller comprises:
an extraction unit configured to extract a candidate parking space list comprising one or more available parking spaces based on the parking area map information;
an available parking space evaluation unit configured to allocate a priority order to each of the available parking spaces comprised in the candidate parking space list based on preset priority order allocation condition information; and
a parking space determination unit configured to determine a target parking space for a subject vehicle based on priority order information allocated to each of the available parking spaces.

17. A parking control system comprising:
an image sensor capable of being disposed in a vehicle so as to have a field of view of exterior of the vehicle, the image sensor configured to capture image data;
a non-image sensor disposed in the vehicle so as to sense the exterior of the vehicle, the non-image sensor configured to capture sensing data;
a controller comprising at least one processor configured to process at least one of the image data captured by the image sensor and the sensing data captured by the non-image sensor; and
a communication unit configured to communicate with at least one of the controller and the server,
wherein the communication unit receives parking area map information from the server, and
wherein the controller comprises:
an extraction unit configured to extract a candidate parking space list comprising one or more available parking spaces based on the parking area map information;
an available parking space evaluation unit configured to allocate a priority order to each of the available parking spaces comprised in the candidate parking space list based on preset priority order allocation condition information; and
a parking space determination unit configured to determine a target parking space for a subject vehicle based on priority order information allocated to each of the available parking spaces.

18. A parking control system comprising:
an image sensor capable of being disposed on a vehicle so as to have a field of view of the exterior of the vehicle, the image sensor configured to capture image data;
a non-image sensor disposed in the vehicle so as to sense the exterior of the vehicle, the non-image sensor configured to capture sensing data;
a domain control unit configured to process at least one of the image data captured by the image sensor and the sensing data captured by the non-image sensor; and
a communication unit configured to communicate with at least one of the domain control unit and the server,
wherein the communication unit receives parking area map information from the server, and
wherein the domain control unit extracts a candidate parking space list comprising one or more available parking spaces based on the parking area map information, allocates a priority order to each of the available parking spaces comprised in the candidate parking space list based on preset priority order allocation condition information, and determines a target parking space for a subject vehicle based on priority order information allocated to each available parking space.
